(19) United States
(12) Patent Application Publication
(10) Pub. No.: US 2005/0068879 A1
(43) Pub. Date: Mar. 31, 2005

(54) Optical scanning device

(76) Inventors: Teunis Willem Tukker, Eindhoven (NL); Bernardus Hendrikus Wilhelmus Hendriks, Eindhoven (NL)

Correspondence Address: Philips Electronics North America Corporation;Corporate Patent Counsel, PO Box 3001, Briarcliff Manor, NY, 10510, US

(21) Appl. No.: 10/498,762

(22) PCT Filed: Dec. 6, 2002
(86) PCT No.: PCT/IB02/05245

(30) Foreign Application Priority Data
Dec. 19, 2001 (EP) 01204994.6
Nov. 8, 2002 (EP) 02079698.3

(51) Int. Cl. G11B 7/00

(52) U.S. Cl. 369/106

(57) ABSTRACT

An optical scanning device is for scanning an information layer (2) with a radiation beam (4). It includes: a radiation source (6) for providing said radiation beam, a lens system (7) for transforming said radiation beam to a scanning spot (17) on said information layer, and a wavefront modifier arranged between said radiation source and said scanning spot. The modifier including two elements (301, 302) having each an aspheric surface (301b, 302a) and being mutually linearly movable for introducing a wave-front modification in said second radiation beam. According to the invention, the aspheric surfaces are shaped so that: a first mutual linear displacement of the elements (301, 302) introduces a first wavefront modification (Wₐ) along a first axis (X_{O}) in said second radiation beam, and a second mutual linear displacement of the elements introduces a second wavefront modification (W_{b}) along said second axis (Y_{O}) in said second radiation beam.

The invention relates to an optical scanning device for scanning an information layer of an optical record carrier by means of a radiation beam, including: (i) a radiation source for providing said radiation beam, (ii) a lens system for transforming said radiation beam to a converging radiation beam so as to form a scanning spot in the position of the information layer, the lens system including a first objective lens having an optical axis, and (iii) a wavefront modifier arranged between said radiation source and the position of said scanning spot for transforming a first radiation beam into a second radiation beam, the wavefront modifier including a first element having a first aspheric surface and a second element having a second aspheric surface, said first and second elements being mutually linearly movable for introducing a wavefront modification in said second radiation beam.

The invention also relates to a wavefront modifier for transforming a first radiation beam into a second radiation beam, the wavefront modifier including a first element having a first aspheric surface and a second element having a second aspheric surface, said first and second elements being mutually linearly movable for introducing a wavefront modification in said second radiation beam.

“Scanning an information layer” refers to scanning by means of a radiation beam for reading information in the information layer (“reading mode”), writing information in the information layer (“writing mode”), and/or erasing information in the information layer (“erase mode”). “Information density” refers to the amount of stored information per unit area of the information layer. It is determined by, inter alia, the size of the scanning spot formed by the scanning device on the information layer to be scanned. The information density may be increased by decreasing the size of the scanning spot. Since the size of the spot depends, inter alia, on the wavelength and the numerical aperture of the radiation beam forming the spot. The size of the scanning spot can be decreased by increasing the numerical aperture and/or by decreasing the wavelength.

A radiation beam propagating along an optical path has a wavefront W with a predetermined shape, given by the following equation:

$$\frac{W}{λ} = \frac{Φ}{2 π} \qquad ( 0 a )$$

where “λ” and “Φ” are the wavelength and the phase of the radiation beam, respectively.

A “wavefront aberration” refers to the following. A first optical element with an optical axis, e.g. an objective lens, for transforming an object to an image may deteriorate the image by introducing the “wavefront aberration” W_{abb}. Wavefront aberrations have different types expressed in the form of the so-called Zernike polynomials with different orders. Wavefront tilt or distortion is an example of a wavefront aberration of the first order. Astigmatism and curvature of field and defocus are two examples of a wavefront aberration of the second order. Coma is an example of a wavefront aberration of the third order. Spherical aberration is an example of a wavefront aberration of the fourth order. For more information on the mathematical functions representing the aforementioned wavefront aberrations, see, e.g. the book by M. Born and E. Wolf entitled “Principles of Optics,” pp.464-470 (Pergamon Press 6^{th} Ed.) (ISBN 0-08-026482-4).

A “wavefront modification” refers to the following. A second optical element with an optical axis, e.g. a non-periodic phase structure, may be arranged in the optical path of the radiation beam for introducing a “wavefront modification” ΔW in the radiation beam. The wavefront modification ΔW is a modification of the shape of the wavefront W. Like the wavefront aberration, the wavefront modification may be symmetric or asymmetric, of a first, second, etc. order of a radius in the cross-section of the radiation beam if the mathematical function describing the wavefront modification ΔW has a radial order of first, second, etc., respectively. The wavefront modification ΔW may also be “flat”; this means that the second optical element introduces in the radiation beam introduces a constant phase change so that, after taking modulo 2π of the wavefront modification ΔW, the resulting wavefront is constant. The term “flat” does not necessarily imply that the wavefront W exhibits a zero phase change. Furthermore, it can be derived from Equation (0a) that the wavefront modification ΔW may be expressed in the form of a phase change ΔΦ of the radiation beam, given by the following equation:

$$Δ Φ = \frac{2 π}{λ} Δ W \qquad ( 0 b )$$

“OPD” of either a wavefront modification or a wavefront aberration refers to the Optical Path Difference of the wavefront aberration or modification. The root-mean-square value OPDᵣₘₛ of the optical path difference OPD is given by the following equation:

$${OPD}_{rms} = \sqrt{\frac{\int \int {f ( r , θ )}^{2} r ⅆ r}{\int \int r ⅆ r ⅆ θ} - {( \frac{\int \int {f ( r , θ )}^{2} r ⅆ r ⅆ θ}{\int \int r ⅆ r ⅆ θ} )}^{2}} \qquad ( 0 c )$$

where “f” is the mathematical function which describes the wavefront aberration or the wavefront modification and “r” and “θ” are the polar coordinates of the polar coordinate system (r, θ) in a plane normal to the optical axis, with the origin of the system is the point of intersection of that plane and the optical axis and extending over the entrance pupil of the corresponding optical element.

Two values OPD_{rms,1} and OPD_{rms,2} are “substantially equal” to each other in the case where |OPD_{rms,1}−OPD_{rms,2}| is equal to, or less than, preferably 30 mλ where the value 30 mλhas been chosen arbitrarily. Similarly, two values OPD_{rms,1} and OPD_{rms,2} are “substantially different” from each other in the case where |OPD_{rms,1}−OPD_{rms,2}| is equal to, or more than, preferably 30 mλ where the value 30 mλ has been chosen arbitrarily.

A wavefront modification “substantially compensates” a wavefront aberration present in a radiation beam in the case where the value OPDᵣₘₛ of the sum of the wavefront modification and the wavefront aberration is substantially is equal to or less than preferably 30 mλ, where the value 30 mλ has been chosen arbitrarily. The radiation beam is then said to be “free of aberration”.

A “wavefront modifier” is used for introducing a wavefront modification by introducing path length differences in dependence on the position in the cross-section of a radiation beam. Such modifier may be used for changing properties of the radiation beam such as its vengeance by introducing a focus curvature in the wavefront of the beam or to change the direction of the beam by introducing tilt. A wavefront modifier may also operate as a wavefront compensator for compensating an unwanted wavefront aberration.

When scanning an optical record carrier having the shape of a disc with an optical scanning device of the type described in the opening paragraph, a problem is the generation of coma in the converging beam due to a warpage of the disc in the radial direction of the disc. Such warpage results in the presence of a tilt between the optical axis of the objective lens and the normal direction of the disc. This problem is even more critical in case of record carriers having high information density, where the numerical aperture of the radiation beam incident on the record carrier is relatively high. For instance, this is the case for record carriers of the so-called DVD+RW format, where the numerical aperture of the incident beam approximately equals 0.65.

A solution to said problem of generation of coma consists in using a wavefront modifier arranged in the optical path of the light between the radiation source and the position of the scanning spot, the modifier comprising a pair of plates having each a flat surface and an aspheric surface. Such a modifier is known from the article by I. Palusinski et al entitled “Lateral shift variable aberration generators”, Applied Optics Vol. 38 (1999) pp. 86-90. The plates are complementary such that when mated they form a flat plate having no optical power. A mutual linear displacement of the two plates in one direction perpendicular to the optical axis of the lens system results in the generation of a wave-front deformation which depends on the linear displacement and the shape of the aspheric surfaces.

A drawback of the known wavefront modifier is to compensate coma only in one direction. Therefore, in order to compensate, e.g., coma in the radial direction and in the tangential direction, the known wavefront modifier must be provided with two sets of plates controlled by two actuators, thereby making the construction of the wavefront modifier complex and expensive.

An object of the invention is to provide an optical scanning device including a wavefront modifier with one pair of elements having each an aspheric surface, for correcting a wavefront modification in the converging beam in two different directions, e.g. the radial direction and the tangential direction.

This object is achieved by the optical scanning device as described in the opening paragraph wherein, according to the invention, said first and second aspheric surfaces are shaped so that:
a first mutual linear displacement of said first and second elements over a first distance along a first axis introduces a first wavefront modification along said first axis in said second radiation beam, and that
a second mutual linear displacement of said first and second elements over a second distance along a different, second axis introduces a second wavefront modification along said second axis in said second radiation beam.

An advantage of providing the optical scanning device with such a wavefront modifier is that the optical scanning device can introduce two wavefront modifications along two respective axes, respectively. For instance, a preferred embodiment (see below) of the scanning device can compensate coma present in the converging beam due to a tilt of the record carrier with respect to the optical axis of the objective lens. This advantageously results in providing the optical scanning device with a relatively large tolerance range for tilt of the optical record carrier.

In a more preferred embodiment of the optical scanning device, the shapes of the aspheric surfaces are substantially defined by a function S′(x, y) and S″(x, y), respectively, or, if these shapes are identical, by a function S(x, y), wherein the function(s) S(x, y), S′(x, y) and/or S″(x, y) include(s):
a first term “(x²+y²)²” in order to introduce said first and second wavefront modifications in the form of third-order coma,
a second term “x³+D₃y³” in order to introduce said first and second wavefront modifications in the form of astigmatism, where “D₃” is a non-zero parameter constant in terms of the Cartesian coordinates “x” and “y”, or
a third term “(x²+y²)³” in order to introduce said first and second wavefront modifications in the form of fifth-order coma.

An advantage of designing the shapes of the aspheric surfaces with a function having a term “(x²+y²)²” is to introduce first and second amounts of third-order coma in the first and second direction, respectively, e.g., in the tangential and radial directions, which can be used, e.g., for compensating coma generated by a tilt between the normal direction of the record carrier and the optical axis of the objective lens. This provides the optical device with a larger tolerance to disc tilt.

An advantage of designing the shapes of the aspheric surfaces with a function having a term “x³+D₃y³” is to introduce first and second amounts of astigmatism in the first and second directions, respectively, e.g., in the tangential and radial directions, which can be used, e.g., for compensating astigmatism generated in the optical light path from the radiation source to the scanning spot due to manufacturing errors when making the objective lens. This provides the optical device with larger tolerance margins in the wavefront modification of the conveying beam due to other causes of wavefront distortions.

Another object of the invention is to provide a wavefront modifier for transforming a first radiation beam into a second radiation beam so as to introduce in said second radiation beam a first wavefront modification along a first direction, e.g. the radial direction, and a second wavefront modification along a second, different direction, e.g. the tangential direction.

This object is achieved by the wavefront modifier as described in the opening paragraph wherein, according to the invention, said first and second aspheric surfaces are shaped so that:
a first mutual linear displacement of said first and second elements over a first distance along a first axis introduces a first wavefront modification along said first axis in said second radiation beam, and that
a second mutual linear displacement of said first and second elements over a second distance along a different, second axis introduces a second wavefront modification along said second axis in said second radiation beam.

The objects, advantages and features of the invention will be apparent from the following, more detailed description of the invention, as illustrated in the accompanying drawings, in which:

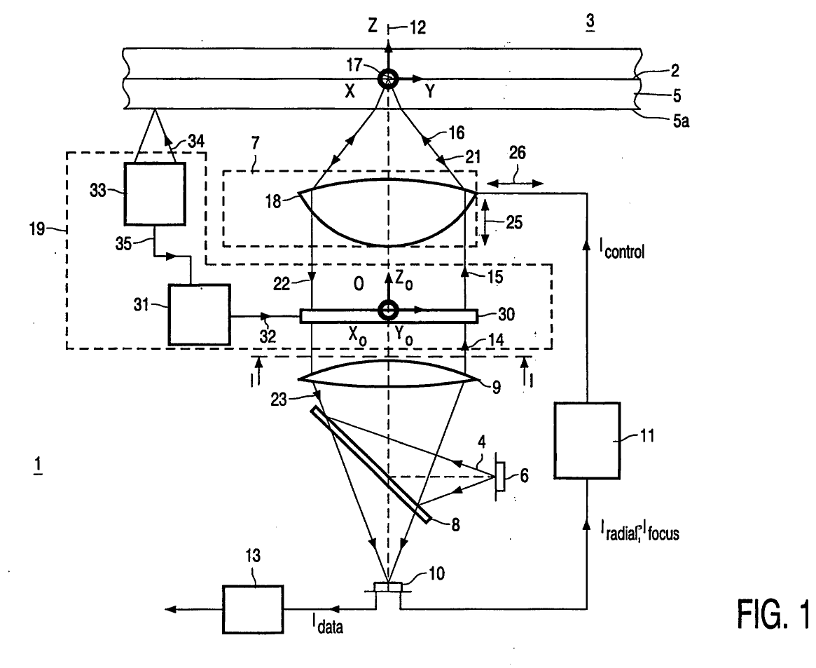

FIG. 1 shows a scanning device including a wavefront modifier according to the invention,

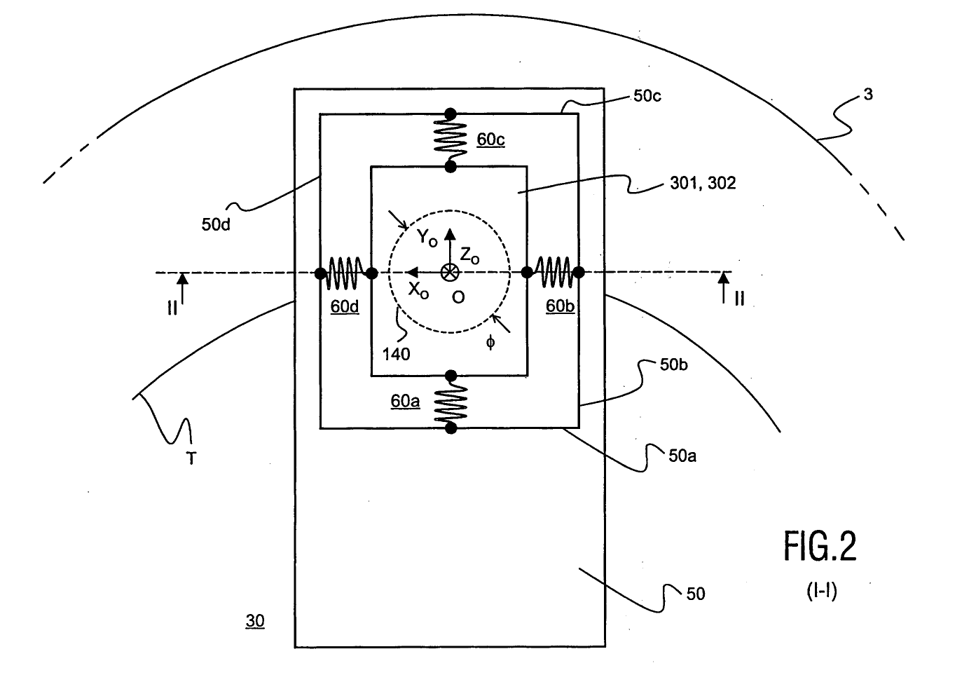

FIGS. 2 through 4 show three views of a preferred embodiment of the wavefront modifier shown in FIG. 1, seen along the line I-I shown in FIG. 1, in three respective positions,

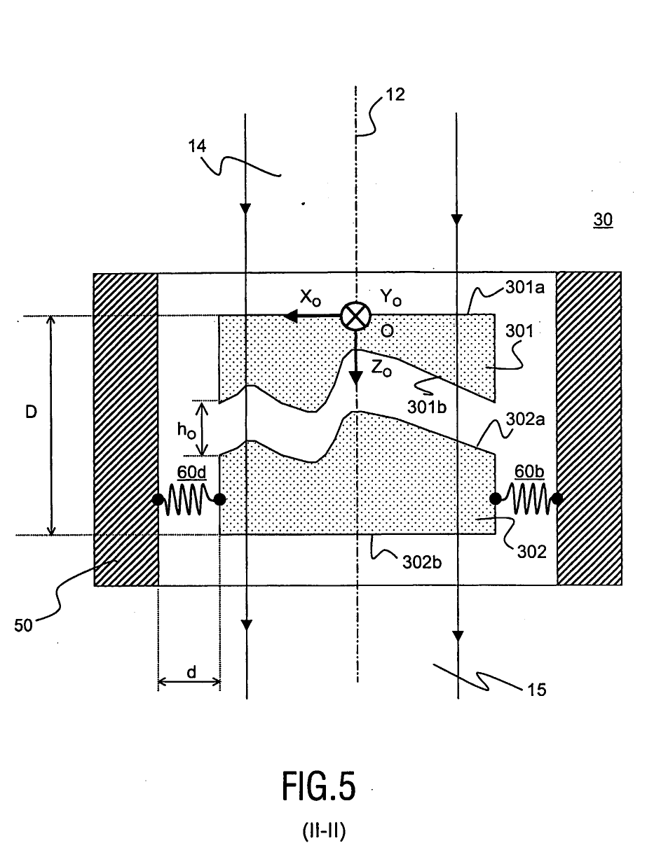

FIGS. 5 through 7 show three cross-sections of the wavefront modifier shown in FIG. 2 seen along the line II-II, the line III-III and the line IV-IV shown in FIGS. 2 through 4, respectively,

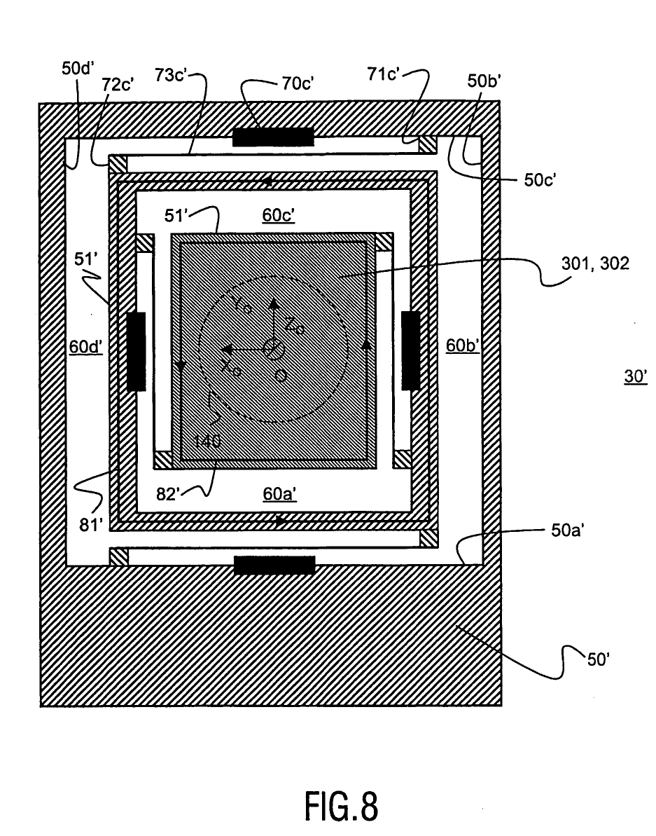

FIG. 8 shows an alternative of the wavefront modifier shown in FIG. 2,

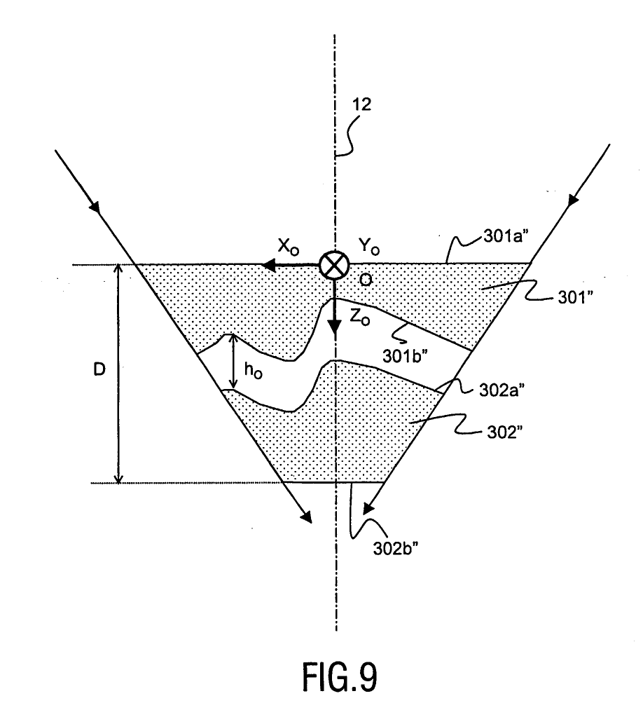

FIG. 9 shows another alternative of the wavefront modifier shown in FIG. 2, and

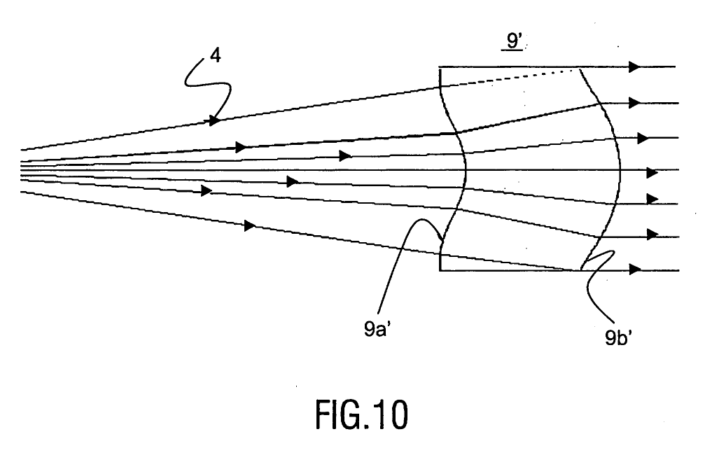

FIG. 10 shows another alternative of the collimator lens shown in FIG. 1.

FIG. 1 shows an optical scanning device 1 according to the invention, which is used scanning a first information layer 2 of a first optical record carrier 3 with a first radiation beam 4.

The record carrier 3 comprises a transparent layer 5, one side of which is provided with the information layer 2. The side of the information layer 2 facing away from the transparent layer 5 may be protected from environmental influences by a protective layer. The transparent layer 5 acts as a substrate for the record carrier 3 by providing mechanical support for the information layer 2. Alternatively, the transparent layer 5 may have the sole function of protecting the information layer 2, while the mechanical support is provided by a layer on the other side of the information layer 2, for instance by the protective layer or by an additional information layer and transparent layer connected to the information layer 2. The information layer 2 is a surface of the record carrier 3 that contains tracks. A track is a path to be followed by a focused or converging radiation beam on which path optically-readable marks that represent information are arranged. In the following, the reference “T” designates such a track. The marks may be, e.g., in the form of pits or areas having a reflection coefficient or a direction of magnetization different from the surroundings. With reference to FIG. 1 and seq. and in the case where the record carrier 3 has the shape of a disc having a center C and includes tracks that are substantially circular with the center C, “Y” is the reference axis parallel to the “radial direction,” that is, the direction between the center C and a point of a track to be scanned, and “X” is the reference axis parallel to the “tangential direction,” that is, the direction that is tangential to the track and perpendicular to the “radial direction” in the plane of the disc. Also with reference to FIG. 1 et seq., “Z” is the reference axis of an optical axis 12 of the optical scanning device 1. It is noted that (X, Y, Z) is a direct orthogonal coordinate system, when the disc 3 is parallel to the plane XY.

By way of illustration only, in the case where the optical record carrier 3 is a disc of the so-called “Blu-ray Disc (BD)”-format, the thickness of the transparent layer 5 approximately equals 0.1 mm. Alternatively, in the case where the record carrier 4 is a disc of the so-called DVD-format, the thickness of the transparent layer 5 approximately equals 0.6 mm.

The optical scanning device 1 includes a radiation source 6, a lens system 7 having an optical axis 12, and a wavefront modifier 30. In the following, “Z_{O}” refers to the optical axis. The device 1 further includes a beam splitter 8, a collimator lens 9, a detection system 10, a servosystem 11, a focus actuator (not shown in FIG. 1), a radial actuator (not shown in FIG. 1), and an information processing unit 14 for error correction.

The radiation source 6 is arranged for supplying the radiation beam 4 for scanning the information layer 2 of the record carrier 3. Preferably, the radiation source 6 includes at least a semiconductor laser that emits the radiation beam 4 at a selected wavelength λ. By way of illustration only, the wavelength λ preferably equals 405 and 660 nm in the case where the record carrier 3 is a BD-format disc and a DVD-format disc, respectively. Furthermore, the radiation source 6 may be provided with a grating structure (not shown in FIG. 1) for forming a first satellite radiation beam and a second satellite radiation beam (which are not shown in FIG. 1) as the −1 and +1 order diffracted radiation beams from the central radiation beam 4.

The beam splitter 8 reflects the radiation beam 4 toward the collimator lens 9. Preferably, the beam splitter 8 is formed by a plane parallel plate that is tilted with respect to the optical axis 12.

The collimator lens 9 transforms the radiation beam 4 to a collimated radiation beam 14.

The lens system 7 transforms the collimated beam 14 into a converging radiation beam 16 so as to form a scanning spot 17 in the position of the information layer 2. The converging beam 16 has a Numerical aperture NA. By way of illustration only, in the case where the optical record carrier 3 is a disc of the so-called BD-format, the numerical aperture NA of the converging beam 16 approximately equals 0.85 for both the reading mode and the writing mode. In the case where the optical record carrier 3 is a disc of the so-called DVD-format, the numerical aperture NA of the converging beam 16 approximately equals 0.60 for the reading mode and 0.65 for the writing mode.

The lens system 7 includes a first objective lens 18 having an entrance surface 18a and an exit surface 18b. The lens system 7 may further include a second objective lens (not shown in FIG. 1), preferably in the case where the numerical aperture NA approximately equals 0.85. The second objective lens, together with the objective lens 18, forms a doublet-lens system that advantageously has a larger tolerance in mutual position of the optical elements than a single-lens system formed only by the objective lens 18. The second objective lens is formed by a plano-convex lens having a convex surface that faces the objective lens 18 and a flat surface that faces the position of the information layer 2. Furthermore, the entrance surfaces and/or exit surfaces of the first and/or second objective lens(es) are preferably aspherically curved for compensating, e.g., spherical aberration, by using a process known from, e.g., the article by B. H. W. Hendriks and P. G. J. M. Nuyens entitled “Designs and manufacturing of far-field high NA objective lenses for optical recording,” 413-414, SPIE 3749 (1999). It is noted that other kinds of wavefront modification can be corrected by designing aspherical lenses. However, such a correction depends on parameters that have been predetermined when designing the lenses; it remains the same irrespective of the actual configuration of the components of the optical scanning device 1, as opposed to the servo correction introduced by the wavefront modifier 30 (see below).

During scanning, the forward converging radiation beam 16 reflects on the information layer 2, thereby forming a backward diverging radiation beam 21 which returns on the optical path of the forward converging radiation beam 16. The lens system 7 transforms the backward radiation beam 21 to a backward collimated radiation beam 22. The collimator lens 9 transforms such a backward collimated radiation beam to a backward non-collimated radiation beam 23. The beam splitter 8 separates the forward radiation beam 4 from the backward radiation beam 23 by transmitting at least part of the backward radiation beam 23 towards the detection system 10.

The detection system 10 is arranged for capturing said part of the backward radiation beam 23 and converting it into one or more electric signals. One of the signals is an information signal S_{data}, the value of which represents the information scanned from the information layer 2. The information signal S_{data} may be processed by the information processing unit 14 for error correction of the information extracted from the information layer 2. Other signals from the detection system 10 are a focus error signal S_{focus} and a radial tracking error signal S_{radial}. The value of the signal S_{focus} represents the axial difference in height along the optical axis 12 between the scanning spot 12 and the information layer 2. The signal S_{focus} is formed by the commonly used “astigmatic method” which is known from, inter alia, the book by G. Bouwhuis, J. Braat, A. Huijser et al, “Principles of Optical Disc Systems,” pp. 75-80 (Adam Hilger 1985) (ISBN 0-85274-785-3). The signal S_{focus} is used for maintaining the scanning spot 17 in focus in the information layer 2. The value of the signal S_{radial} represents the distance in the plane of the information layer 2 between the scanning spot 17 and the center of a track in this information layer to be followed by this scanning spot. The signal S_{radial} is formed by the commonly used “radial push-pull method” which is known from, inter alia, said book by G. Bouwhuis et al., pp. 70-73. The signal S_{radial} is used for maintaining the scanning spot 17 on track in the information layer 2.

The servosystem 11 is arranged for, in response to the signals S_{focus} and S_{radial}, providing control signals S_{control} for controlling the focus actuator and the radial actuator, respectively. The focus actuator controls the positions of the lens system 7 in a direction 25 parallel to the optical axis 12 (axis Z), thereby controlling the position of the scanning spot 17 such that it coincides substantially with the plane of the information layer 2. The radial actuator controls the positions of the lens system 7 in a direction 26 parallel to the radial direction (axis Y), thereby controlling the radial position of the scanning spot 17 such that it coincides substantially with the center line of the track to be followed in the information layer 2.

The wavefront modifier 30 is arranged between the radiation source 6 and the position of the record carrier 3 and transforms an input radiation beam to an output radiation beam. In the embodiment of the optical scanning device 1 shown in FIG. 1, the wavefront modifier 30 is arranged between the collimator lens 9 and a lens system 7, the input and output beams being the collimated radiation 14 and a radiation beam 15, respectively.

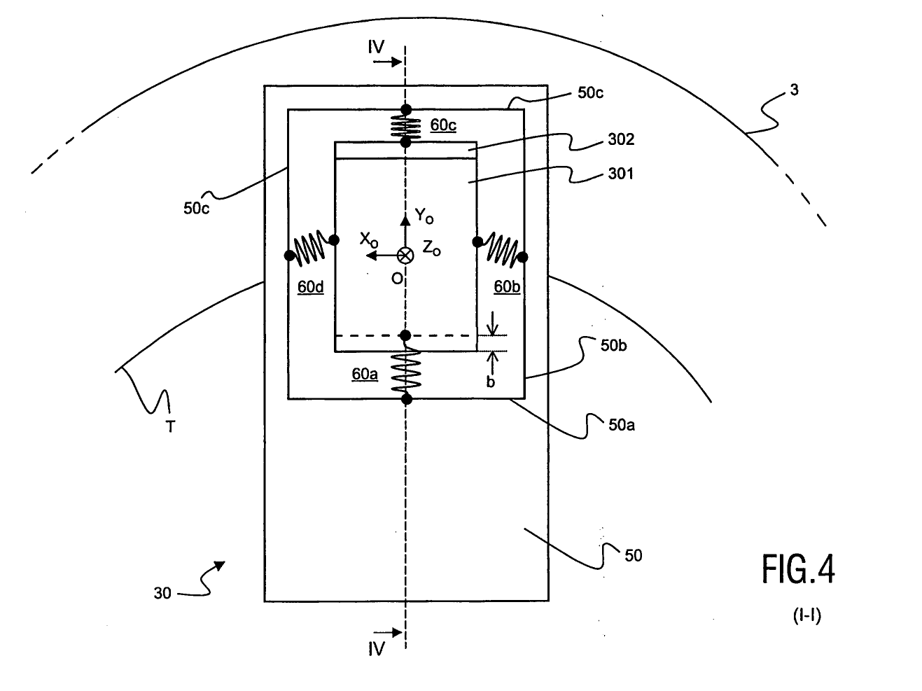

Furthermore, the wavefront modifier 30 includes a first element and a second element (not shown in FIG. 1 but shown in FIG. 2 et seq.) having a first aspheric surface and a second aspheric surface (not shown in FIG. 1 but shown in FIGS. 4 and 5). The first and second elements are mutually linearly movable for introducing a wavefront modification in the radiation beam 15.

According to a first aspect of the invention, the first and second aspheric surfaces are shaped so that: (i) a first mutual linear displacement of the first and second elements over a first distance along a first axis introduces a first wavefront modification Wₐ along said first axis in the output radiation beam of the wavefront modifier, and (ii) a second mutual linear displacement of said first and second elements over a second distance along a different, second axis introduces a second wavefront modification along said second axis in that output radiation beam. Furthermore, the shape of the first aspheric surface is substantially defined by a function S′(x, y) and the shape of said second aspheric surfaces is substantially defined by a function S″(x, y), the functions S′(x, y) and S″(x, y) being determined by:

$${W}_{a} ( x , y ) \approx ( {n}_{1} - 1 ) {a}_{1} \frac{\partial {S}^{′} ( x , y )}{\partial x} - ( {n}_{2} - 1 ) {a}_{2} \frac{\partial {S}^{″} ( x , y )}{\partial x} \\ {W}_{b} ( x , y ) \approx ( {n}_{1} - 1 ) {b}_{1} \frac{\partial {S}^{′} ( x , y )}{\partial y} - ( {n}_{2} - 1 ) {b}_{2} \frac{\partial {S}^{″} ( x , y )}{\partial y} \qquad ( 1 a )$$

where “(x, y)” are Cartesian coordinates in the system X_{O}Y_{O} in a reference plane X_{O}Y_{O}, the system having its origin on the point of intersection O of the optical axis 12 and the reference plane, the X_{O}-axis and the Y_{O}-axis being said first and second axes of linear displacement, respectively, “a1” and “a₂” being the respective displacements of the first and second elements along the X_{O}-axis in case of the first mutual linear displacement, “b₁” and “b₂” being the respective displacements of the first and second elements along the Y_{O}-axis in case of the second mutual linear displacement, “n₁” and “n₂” being the respective optical indices of the first and second elements, and “S′(x, y)” and “S″(x, y)” representing the respective shapes of the first and second aspheric surfaces. By way of illustration only, in the embodiment shown in FIG. 1, both the X_{O}-axis and the Y_{O}-axis are perpendicular to the optical axis 12 so that (O, X_{O}, Y_{O}, Z_{O}) is a direct orthogonal base. It is noted that, in the following, the shape of a given surface is “substantially defined” by a function S means that the actual shape S_{actual} of the surface meets the following condition: 0.9S<S_{actual}<1.1S. Preferably, the actual shape S_{actual} of the surface meets the following condition: 0.95S<S_{actual}<1.05S. More preferably, the actual shape S_{actual} of the surface meets the following condition: 0.99S<S_{actual}<1.0S.

It is noted in (O, X_{O}, Y_{O}, Z_{O}) that the wavefront modifications Wₐ and W_{b} are in the X_{O}- and the Y_{O}-axis, respectively. It is also noted in (O, X_{O}, Y_{O}, Z_{O}) that a distance relative to a displacement along the X_{O}- or Y_{O}-axis has a positive sign when this displacement is in the same direction than the X_{O}- or Y_{O}-axis, respectively, and a negative sign when this displacement is in the opposite direction than the X_{O}- or Y_{O}-axis, respectively.

In a preferred embodiment of the aspheric surfaces as defined by Equations (1a), the shapes of these surfaces are substantially identical and substantially defined by a function S(x, y). Thus, in this embodiment, S(x, y)=S′(x, y)=S″(x, y). In a more preferred embodiment of the aspheric surfaces, the optical indices of the first and second elements are identical. Thus, in this embodiment, n₁=n₂=n. It is found in this embodiment that the function S(x, y) is determined by:

$${W}_{a} ( x , y ) \approx ( n - 1 ) a \frac{\partial S ( x , y )}{\partial x} \\ {W}_{b} ( x , y ) \approx ( n - 1 ) b \frac{\partial S ( x , y )}{\partial x} \qquad ( 1 b )$$

where “a” and “b” being said first and second displacements, respectively, “n” being the optical indices of the first and second elements, and “S(x, y)” representing the respective shapes of the first and second aspheric surfaces. It is noted, in this embodiment, that the distances “a” and “b” satisfy the following conditions:
a=a₁−a₂.
b=b₁−b₂.

By way of illustration only, in the embodiment of the optical scanning device 1 shown in FIG. 1, the wavefront modifier 30 is used for compensating a first amount of third-order coma W₁ along the X_{O}-axis and a second amount of third-order coma W₂ along the Y_{O}-axis that are present in the converging beam 16 due to, e.g., a tilt of the record carrier 3. It is noted that the presence of coma in the converging beam 16 means that coma is present in the radiation beam traversing the transparent layer 5, from the surface 5a of the record carrier 3 to the scanning spot 17. Furthermore, during scanning of a track T (shown, e.g., in FIG. 2) of the record carrier 3, the optical scanning device 1 can be oriented so that the tangential direction (X) and the radial direction (Y) of the track T are parallel to the X_{O}- and the Y_{O}-axes, respectively. Thus, the wavefront modifier 30 can compensate third-order coma in both the radial direction and the tangential direction.

In this embodiment, the optical scanning device 1 includes a coma compensator 19 which includes a coma detector 33, a control circuit 31, and the wavefront modifier 30.

The coma detector 33 provides two detection signals 35, one representative of the amount of coma W₁ and one representative of the amount of coma W₂. In this embodiment, the coma detector 33 is a tilt detector 33 and the detection signal 35 is a tilt signal. The tilt detector 33 emits a radiation beam 34 towards the record carrier 3 and detects the angle of the radiation beam reflected by the record carrier 3 in the tangential and radial directions. The position of the spot of the reflected beam in the plane is a measurement for the angle and, hence, for the tilt of the record carrier 3. The values of tilt measured in the tangential and radial directions are directly proportional to the amounts of coma W₁ and W₂, respectively. The tilt detector 33 transforms that measured value into the tilt signal 35. It is noted that the tilt detector 33 may be of any type. An alternative of the tilt detector 33 shown in FIG. 1 is a tilt detector formed as a part of the control circuit 31, wherein the tilt signal is derived from a combination of output signals of the detection system 10.

The control circuit 31 is arranged for, responsive to the tilt signal 35, providing control signals 32 for controlling the wavefront modifier 30.

The wavefront modifier 30 transforms, in this embodiment, the collimated beam 14 to the radiation beam 15 by introducing, in response to the tilt signal 35, the wavefront modifications Wₐ and W_{b} along the X_{O}- and Y_{O}-axes, respectively, in the radiation beam 15 in order to compensate the amounts of coma W₁ and W₂, where Wₐ, W_{b}, W₁ and W₂ meet the following conditions:
Wₐ(x, y)+W₁(x, y)=0
W_{b}(x, y)+W₂(x, y)=0 (2)

In other words, the wavefront modifier 30 is arranged so that the radiation beam 15 is substantially free of aberration, in this embodiment, free of coma. In the description, “substantially free from aberration” means that the value OPDᵣₘₛ of the resulting amount of aberration (that is, in this embodiment, Wₐ+W₁ or W_{b}+W₂) in the radiation beam (in this embodiment, the collimated beam 15) emerging from the wavefront modifier 30 is preferably less than 30 mλ rms and more preferably less than 15 mλ rms.

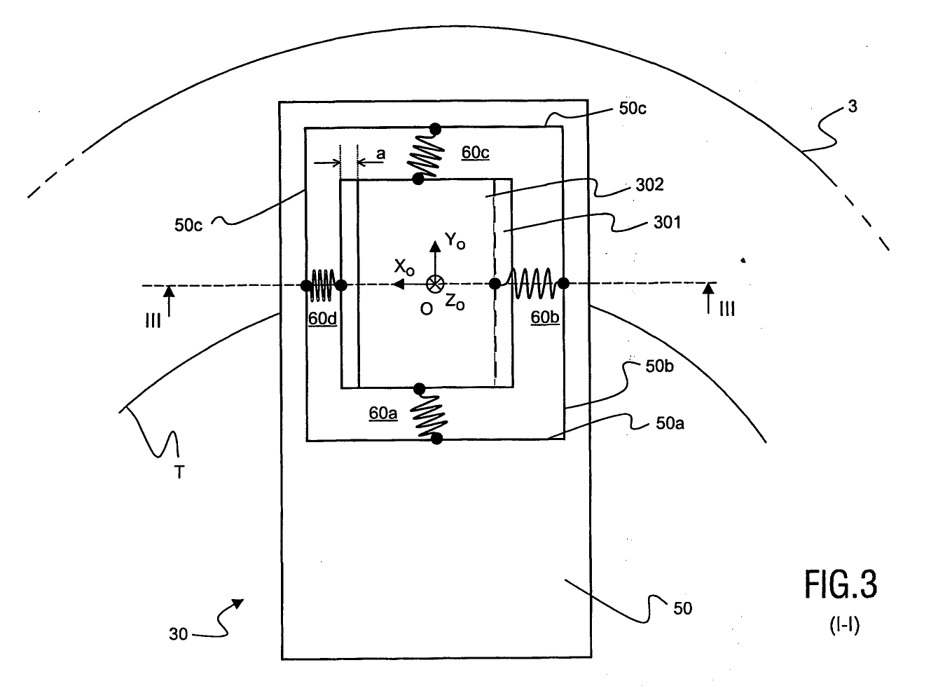

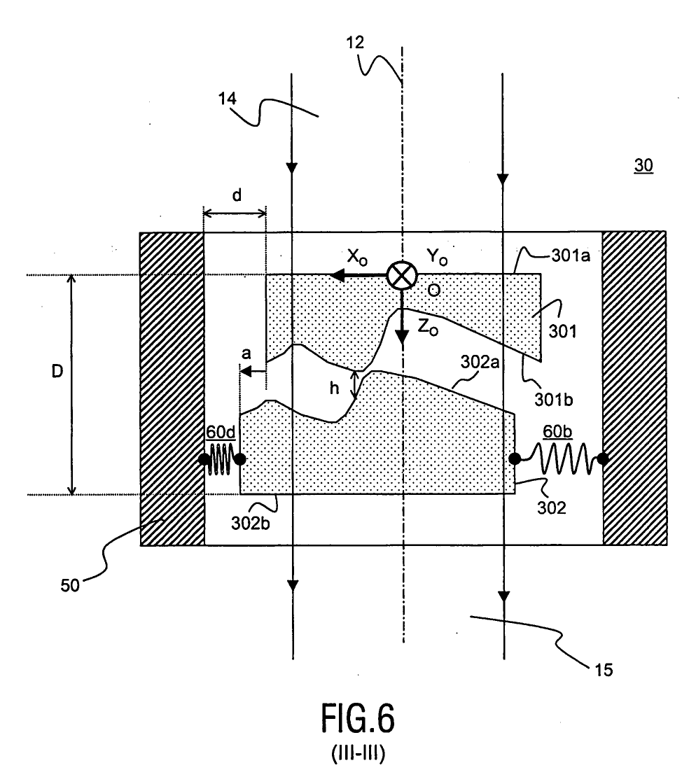

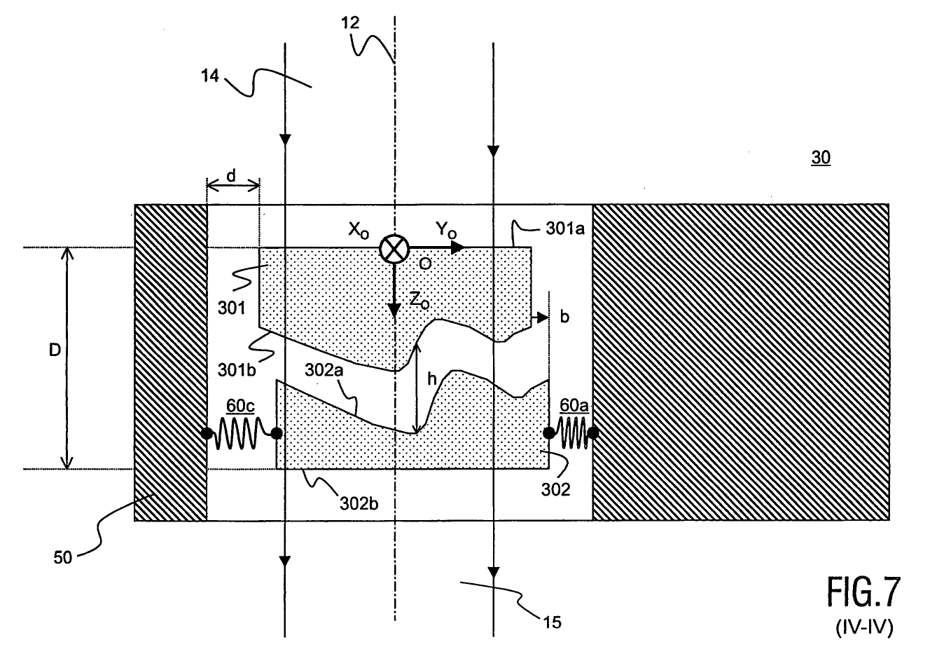

FIGS. 2 through 4 show three views of an embodiment of the wavefront modifier 30 shown in FIG. 1, seen along the line I-I indicated in FIG. 1 in three respective configurations of the wavefront modifier 30. FIG. 5 shows a cross-section of the wavefront modifier 30 shown in FIG. 2, seen along a line II-II indicated in FIG. 2. FIG. 6 shows a cross-section of the wavefront modifier 30 shown in FIG. 3, seen along a line III-III indicated in FIG. 3. FIG. 7 shows a cross-section of the wavefront modifier 30 shown in FIG. 4, seen along a line IV-IV indicated in FIG. 4.

As shown in FIGS. 2 through 7, the wavefront modifier 30 includes the first and second elements which are formed, in this embodiment, by a first plate 301 and a second plate 302, respectively. The wavefront modifier 30 also includes a body 50 for supporting the plates 301 and 302. As shown in FIG. 2, the wavefront modifier 30 further includes four positioning means 60a, 60b, 60c and 60d for enabling, by means of control means (not shown), said first and second linear displacements.

As shown in FIG. 5, the plate 301 has an entrance surface 301a facing the collimator lens 9 and an exit surface 301b facing the plate 302. The exit surface 301b is aspherically curved (as described below). The entrance surface 301a is, in this embodiment, substantially plane. It is noted that the plane entrance surface 301a corresponds, in this embodiment, to the reference plane X_{O}Y_{O}.

Also as shown in FIG. 5, the plate 302 has an entrance surface 302a facing the exit surface 301b of the plate 301 and an exit surface 302b facing the objective lens 18. The entrance surface 302a is aspherically curved (as described below). The exit surface 302b is, in this embodiment, substantially plane, parallel to the X_{O}- and the Y_{O}-axes.

It is noted that, in this embodiment, said first and second aspheric surfaces are formed by the exit surface 301b and the entrance surface 302a. It is also noted, in this embodiment, that the shapes of the aspheric surfaces 301b and 302a are identical (and therefore satisfy Equations (1b)).

By way of illustration only, the plates 301 and 302 can be made of plastic, e.g. the material commonly known in the commerce under the designation PMMA, where the optical index equals, e.g., 1.5066.

The body 50 has four inner walls 50a through 50d arranged so as to form an opening through the body 50 in which the plates 301 and 302 are provided as explained below. By way of illustration, the body 50 is made of aluminum.

It is noted that, in FIGS. 2 and 5, the first configuration of the wavefront modifier 30 corresponds to a configuration of the plates 301 and 302 where these plates mate each other so as to form a plane parallel plate. In FIGS. 3 and 6, the second configuration of the wavefront modifier 30 corresponds to a configuration of the plates 301 and 302 in case of the second mutual linear displacement between the plates. In FIGS. 4 and 7, the third configuration of the wavefront modifier 30 corresponds to a configuration of the plates 301 and 302 in case of the second mutual linear displacement between these plates.

In the first configuration of the wavefront modifier 30 (shown in FIGS. 2 and 5), the plates 301 and 302 mate each other. Thus, there is a first gap between these plates, with a height “h” along the Z_{O}-axis which, in this configuration, equals a substantially constant value, h₀. The choice of the value of the height h_{O} is explained below. There is also a second gap between the plate 301 and the body 50, with a height “d” which is substantially constant, as shown in FIG. 5. By way of illustration only, the height d is typically equal to 0.3 mm. It is noted, in this first configuration, that the total thickness D, i.e. the sum of the thickness of the plate 301, the first gap, and the thickness of the plate 302 along the Z_{O}-axis, is substantially constant. By way of illustration only, the total thickness D approximately equals 2 mm. It is noted in the first configuration of the wavefront modifier 30 that the positions of the surfaces 301a, 301b, 302a and 302b in the base (O, X_{O}, Y_{O}, Z_{O}) are equal to 0, S(x, y), h₀+S(x, y) and D, respectively.

In the second configuration of the wavefront modifier 30 (shown in FIGS. 3 and 6), the plate 302 is moved over the distance “a” along the X_{O}-axis and the plate 301 is stationary, that is, is in the same position in the (O, X_{O}, Y_{O}, Z_{O}) than in said first configuration. The choice of the value of the distance “a” is explained below. It is noted, in the second configuration, that the height h between the plates 301 and 302 is no longer substantially constant, because of the asphericity of the surfaces 301b and 302a. This results in different optical paths for the radiation beam emerging from the exit surface 301b of the plate 301. As a result, in the second configuration, the wavefront modification Wₐ is introduced in the radiation beam 15 for correcting the amount of coma W₁, as explained further.

In the third configuration of the wavefront modifier 30 (shown in FIGS. 4 and 7), the plate 302 is moved over the distance “b” along the Y_{O}-axis and the plate 301 is stationary, that is, is in the same position in the (O, X_{O}, Y_{O}, Z_{O}) than in said first configuration. The choice of the value of the distance “b” is explained below. It is noted, in the second configuration, that the height h between the plates 301 and 302 is no longer substantially constant, because of the asphericity of the surfaces 301b and 302a. This results in different optical paths for the radiation beam emerging from the exit surface 301b of the plate 301. As a result, in the third configuration, the wavefront modification W_{b} is introduced in the radiation beam 15 for correcting the amount of coma W₂, as explained now.

The designing of the shapes of the aspheric surfaces 301b and 302a is now described, in the particular case where the amount of third-order coma W₁ and W₂ to be compensated along the X_{O}- and Y_{O}-axes, respectively, are represented as follows:
W₁(x, y)=A₁x(x²+y²)
W₂(x, y)=A₂y(x²+y²) (3)
where “(x, y)” are the Cartesian coordinates in the reference plane X_{O}Y_{O}, “A₁” and “A₂” are two parameter which are constant in terms of (x, y) and which depends on the value of the tilt angle of the disc-shaped record carrier 3. In the following, “S₁” refers to the function “S” determined in respect of Equations (1b) and for this particular case.

When substituting Equations (3) in Equations (2), it is found in the (O, X_{O}, Y_{O}, Z_{O}) base that:
Wₐ(x, y)=−A₁y(x²+y²) (4)
W_{b}(x, y)=−A₂y(x²+y²) (4)
After substituting Equation (1b) in Equation (4), it is found that the function S₁(x, y) is given by:
S₁(x, y)=C₁(x²+y²)² (5)
where “C₁” is a non-zero parameter constant in (x, y).

Therefore, the shapes of the aspheric surface 301b and 302a can be designed, in this example, by choosing the values of the parameter C₁ in Equation (5). The displacement distances “a,” and “b” are known by substituting Equation (5) in Equations (1b) and is then given by:

$$a = \frac{- {A}_{1}}{( n - 1 ) {C}_{1}} \\ b = \frac{- {A}_{2}}{( n - 1 ) {C}_{1}} \qquad ( 6 )$$

Thus, the choice of the distances “a” and “b” depends on the choice of the parameters A₁, A₂, (n−1) and on the value of the parameter C₁. Furthermore, for two given values of the amounts of third-order coma W₁ and W₂, that is, for two given values of the parameters A₁ and A₂, there is a trade-off when choosing the values of the parameter C₁ and of the distances “a” and “b”. For instance, if a large value of the parameter C₁ is chosen, the aspheric surface 301b is then designed with a relatively large peak-to-peak value in height. This results in an important curvature of the surface 302a, thereby making the plate 302 difficult to be displaced. By contrast, the choice of a large value of the distance “a” or “b” requires a displacement of the plate 302 in the body 50 with a large amplitude, thereby making the wavefront modifier 30 difficult to make. By way of illustration only, the values of the distances “a” and “b” are comprised between −0.3 and +0.3 mm.

Furthermore, the value h₀ of the height h (shown in FIG. 5) must be chosen in order to enable the mutual positioning of the aspheric surfaces 301b and 302a. It is noted that the choice of the value h₀ is dependent on the displacements of the plate 302 over the distances “a” and “b” and on the parameter C₁. Thus, a large value h₀ allows the plate 302 to be displaced without being into contact with the stationary plate 301. However, it is noted that the displacements of the plate 302 over the distances “a” and “b” also generate an amount of astigmatism W₃ that depends on the height of the gap between the plates 301 and 302. Ray-tracing simulations have been made from Equation (5) with different values h₀. The results of these simulations are shown in Table 1 below. Table 1 shows the root-mean-square values W_{1,rms}, W_{2,rms} and W_{3,rms} of the amounts of coma W₁ and W₂ and of the amount of spherical aberration W₃, respectively, for the different values h₀, in the case where the shapes of the aspheric surfaces 301b and 302a are defined by the function S₁ according to Equation (5) and under the following conditions: a=0.05 mm; b=0.05 mm; C₁=0.001 mm⁻¹; φ=3 mm; and λ=405 mm, where “φ” and “λ” are the diameter and the wavelength of the collimated beam 14, respectively. It is noted that coma and astigmatism have been expressed in the form of the Zernike coefficients as known, e.g., from said book by M. Born, pp. 469-470.

TABLE 1

| h₀ (mm) | W_{1,rms} (mλ) | W_{2,rms} (mλ) | W_{3,rms} (mλ) |
|---|---|---|---|
| 0 | 100 | 100 | 0 |
| 1 | 101 | 101 | 7 |
| 5 | 106 | 106 | 35 |

Therefore, the value h₀ must be chosen sufficiently high such that the plate 302 can be displaced without being into contact with the stationary plate 301. It must also be sufficiently low so that the displacements of the plate 302 generate low amounts of spherical aberration W₃. It has been found that the value ho must be higher than 5.1 μm.

It is to be appreciated that numerous variations and modifications may be employed in relation to the embodiments described above, without departing from the scope of the invention which is defined in the appended claims.

In particular, the wavefront modifier 30 shown in FIGS. 1 through 7 may be adapted for modifying a wavefront modification other than coma in the tangential direction. It is noted, by deriving Equations (1b) with respect to the Cartesian coordinates (x, y), that the wavefront modifications Wₐ(x, y) and W_{b}(x, y) must satisfy the following condition:

$$\frac{{\partial }^{2} S ( x , y )}{\partial x \partial y} \approx \frac{1}{( n - 1 ) a} \frac{\partial {W}_{a} ( x , y )}{\partial y} = \frac{1}{( n - 1 ) b} \frac{\partial {W}_{b} ( x , y )}{\partial x} \qquad ( 7 a )$$

Equation (7a) can be simplified as follows:

$$\frac{\partial {W}_{a} ( x , y )}{\partial y} = B \frac{\partial {W}_{b} ( x , y )}{\partial x} \qquad ( 7 b )$$

where “B” is a non-zero parameter constant in terms of the Cartesian coordinates “x” and “y”. Thus, there is a function Sᵢ(x, y) resolving both Equations (1b) only if the wavefront modifications Wₐ(x, y) and W_{b}(X, y) meets Equation (7b).

Table 2 shows various types of the wavefront modifications Wₐ(x, y) and W_{b}(x, y) along the X_{O}- or Y_{O}-axis (indicated into parentheses), their respective representations Wₐ(x, y) and W_{b}(X, y) in the form of the Zernike coefficients (as known, e.g., from said book by M. Born, pp. 469-470), and the derivatives of these representations with respect to the corresponding Cartesian coordinates x and y. It is noted that the representations of the wavefront modifications Wₐ(x, y) and W_{b}(x, y) are the Zernike coefficients as known, e.g., from said book by M. Born, pp. 469-470. In Table 2, “W_{a,b}(x, y)” refers to the wavefront modification “Wₐ(x, y)” and/or the wavefront modification “W_{b}(x, y)”.

TABLE 2

| Types of W_{a,b}(x, Y) | W_{a,b}(x, Y) | $\frac{\partial {W}_{a , b} ( x , y )}{\partial x}$ | $\frac{\partial {W}_{a , b} ( x , y )}{\partial y}$ |
|---|---|---|---|
| Tilt (X_{O}) | x | 1 | 0 |
| Tilt (Y_{O}) | y | 0 | 1 |
| Defocus (X_{O}or Y_{O}) | x² + y² | 2x | 2y |
| Astigmatism (X_{O}) | x² | 2x | 0 |
| Astigmatism (Y_{O}) | y² | 0 | 2y |
| Third-order coma (X_{O}) | x(x² + y²) | 3x² + y² | 2xy |
| Third-order coma (Y_{O}) | y(x² + y²) | 2xy | 3y² + x² |
| Fifth-order coma (X_{O}) | x(x² + y²)² | (x² + y²)(3x² + y²) | xy(x² + y²) |
| Fifth-order coma (Y_{O}) | y(x² + y²)² | (x² + y²)(x² + 3y²) | xy(x² + y²) |
| Spherical (X_{O}or Y_{O}) | (x² + y²)² | 4x(x² + y²) | 4y(x² + y²) |
| Line coma (X_{O}) | x³ | 3x | 0 |
| Line coma (Y_{O}) | y³ | 0 | 3y² |

From Equation (7b) (where the distances “a” and “b” are identical, that is, where a=b) and from Table 2, it is found that the following functions Sᵢ(x, y) (where i=2, 3 . . . ) can introduce the wavefront modifications Wₐ(x, y) and W_{b}(x, y).

In order to introduce the wavefront modifications Wₐ(x, y) and W_{b}(x, y) in the form of tilt, the shapes of the aspheric surfaces are defined by the function S₂(x, y) given by:
S₂(x, y)=C₂(x²+D₂y²) (8a)
where “C₂” and “D₂” are non-zero parameters constant in terms of the Cartesian coordinates “x” and “y”.

In order to introduce the wavefront modification Wₐ(x, y) in the form of astigmatism and the wavefront modification W_{b}(x, y) in the form of tilt, the shapes of the aspheric surfaces are defined by the function S₃(x, y) given by:
S₃(x, y)=C₃(x³+D₃y²) (8b)
where “C₃” and “D₃” are non-zero parameters constant in terms of the Cartesian coordinates “x” and “y”.

In order to introduce the wavefront modification Wₐ(x, y) in the form of line coma and the wavefront modification W_{b}(x, y) in the form of tilt, the shapes of the aspheric surfaces are defined by the function S₄(x, y) given by:
S₄(x, y)=C₄(x⁴+D₄y²) (8c)
where “C₄” and “D₄” are non-zero parameters constant in terms of the Cartesian coordinates “x” and “y”.

In order to introduce the wavefront modification Wₐ(x, y) in the form of tilt and the wavefront modification W_{b}(x, y) in the form of astigmatism, the shapes of the aspheric surfaces are defined by the function S₅(x, y) given by:
S₅(x, y)=C₅(x²+D₅y³) (8d)
where “C₅” and “D₅” are non-zero parameters constant in terms of the Cartesian coordinates “x” and “y”.

In order to introduce the wavefront modifications Wₐ(x, y) and W_{b}(x, y) in the form of astigmatism, the shapes of the aspheric surfaces are defined by the function S₆(x, y) given by:
S₆(x, y)=C₆(x³+D₆y³) (8e)
where “C₆” and “D₆” are non-zero parameters constant in terms of the Cartesian coordinates “x” and “y”.

In order to introduce the wavefront modification Wₐ(x, y) in the form of line coma and the wavefront modification W_{b}(x, y) in the form of astigmatism, the shapes of the aspheric surfaces are defined by the function S₇(x, y) given by:
S₇(x, y)=C₇(x⁴+D₇y³) (8f)
where “C₇” and “D₇” are non-zero parameters constant in terms of the Cartesian coordinates “x” and “y”.

In order to introduce the wavefront modification Wₐ(x, y) in the form of tilt and the wavefront modification W_{b}(x, y) in the form of line coma, the shapes of the aspheric surfaces are defined by the function S₈(x, y) given by:
S₈(x, y)=C₈(x²+D₈y⁴) (8g)
where “C₈” and “D₈” are non-zero parameters constant in terms of the Cartesian coordinates “x” and “y”.

In order to introduce the wavefront modification Wₐ(x, y) in the form of astigmatism and the wavefront modification W_{b}(x, y) in the form of line coma, the shapes of the aspheric surfaces are defined by the function S₉(x, y) given by:
S₉(x, y)=C₉(x³+D₉y⁴) (8h)
where “C₉” and “D₉” are non-zero parameters constant in terms of the Cartesian coordinates “x” and “y”.

In order to introduce the wavefront modifications Wₐ(X, y) and W_{b}(x, y) in the form of line coma, the shapes of the aspheric surfaces are defined by the function S₁₀(x, y) given by:
S₁₀(x, y)=C₁₀(x⁴+D₁₀y⁴) (8i)
where “C₁₀” and “D₁₀” are non-zero parameters constant in terms of the Cartesian coordinates “x” and “y”.

In order to introduce the wavefront modifications Wₐ(x, y) and W_{b}(x, y) in the form of fifth-order coma, the shapes of the aspheric surfaces are defined by the function S₁₁(x, y) given by:
S₁₁(x, y)=C₁₁(x²+y²)³ (8j)
where “C₁₁” is a non-zero parameter constant in terms of the Cartesian coordinates “x” and “y”.

It is noted that the functions S′(x, y) and S″(x, y) defined in respect of Equations (1a) may have the same terms than the functions Sᵢ(x, y) (where i=1, 2, . . . ) in order to introduce the same wavefront modifications Wₐ(x, y) and W_{b}(x, y).

It is noted that the functions S₁(x, y) through S₁₁(x, y) are not disclosed in said article by Palusinski.

In an alternative of the wavefront modifier described above in respect of the functions Sᵢ(i=0, 1, 2 . . . ), these functions may include at least a step-function Q(x, y) which equals a nonzero constant parameter “q” for a portion of the corresponding aspheric surface, and zero for the remaining part of that surface. The parameter “q” is substantially equal to mλ/(n−1) where “λ” is the wavelength of the input radiation beam of the wavefront modifier, “m” is an integer value and “n” is the refractive index of the corresponding plate. Hence, the corresponding plate is modified in a similar way as a Fresnel lens known, e.g., from the book by W. J. Smith, “Modern Optical Engineering”, pp.257-258 (McGraw-Hill, 2d Ed.) (ISBN 0-07-059174-1)). It is noted that the functions S′(x, y) and S″(x, y) may also include such a step-function Q.

FIG. 8 shows an alternative to the wavefront modifier 30 shown in FIG. 2, designated by the numeral reference 30′. As shown in FIG. 8, the wavefront modifier 30′ includes a body 50′, a first support element 51′, a second support element 52′ provided with the plates 301 and 302, and four positioning means 60a′, 60b′, 60c′ and 60d′ controlled, in the embodiment of the wavefront modifier shown in FIG. 1, by the control signals 32 of the control circuit 31. Each of the four positioning means, e.g. the positioning means 60c′, includes a control means formed by a magnet, e.g. a magnet 70c′, two fixed elements, e.g. elements 71c′ and 72c′, a spring, e.g. a spring 73c′. Furthermore, the support elements 51′ and 52′ are provided with a first coil 81′ and a second coil 82′, respectively.

As an improvement of the wavefront modifier according to the invention and with reference to FIG. 1, the wavefront modifier can be provided with a position detector which is known from PHN 17.844, incorporated herein by reference. Indeed, it is noted that the wavefront modifications Wₐ and W_{b} introduced by the aberration compensator 30 will only compensate the amounts of coma W₁ and W₂ if the introduced modification is correctly centered with respect to the optical axis, 12 of the objective lens 18. The compensation is not correct if the wavefront modifications Wₐ and W_{b} are centered on the axis of the collimated beam 14 and if the objective lens 18 is displaced in the radial direction (Y) of the track to be scanned because of radial tracking.

In another alternative of the optical scanning device according to the invention and with reference to FIG. 1, the wavefront modifier 30 may be arranged in the optical path of the light between the radiation source and the position of the scanning spot other than in the optical path of the collimated beam 14. It is noted that the shapes of the plates 301 and 302 must be adapted to the dimensions of the radiation beam in the optical path of which the wavefront modifier is arranged. By way of illustration only, FIG. 9 shows an alternative to the plates 301 and 302 shown in FIG. 5, designated by the numeral reference 301′ and 302′. As shown in FIG. 9, the plates 301′ and 302′ are arranged in the optical path of a diverging radiation beam and the surfaces 301a′, 301b′, 302a′ and 302b′ are adapted to the variable dimensions of the radiation beam along its axis of propagation. As an example, such an alternative may be integrated with the objective lens 18 where the latter is formed by a first element and a second element having a first aspheric surface and a second aspheric surface according to the invention. Alternatively, the wavefront modifier 30 may be integrated with another optical component of the scanning device 1, e.g. the collimator lens 9 or the beam splitter 8.

In another alternative of the optical scanning device according to the invention and with reference to FIG. 1, the wavefront modifier 30 may be arranged so that the first and second elements are mutually linearly displaced along the Z_{O}-axis, that is, along the optical axis of the objective lens 18.

In another alternative of the optical scanning device according to the invention and with reference to FIG. 1, the radiation beam entering the lens system 7 has a high rim intensity in order to decrease the size of the scanning spot 17 and therefore to increase the information density of the information layer 2. In the present description “rim intensity” means the intensity at the rim of the cross-section of the beam normal to the optical axis, divided by the intensity at the center of the beam. “High rim intensity” means that the rim intensity is higher than 70%, preferably 80% and, more preferably, 90%. It is noted that that the rim intensity may be higher than 100%.

One way to increase the rim intensity of the radiation beam is to decrease the numerical aperture of the collimator lens. However, such a decrease will result in decreasing the light path power efficiency to the optical record carrier. In the present description “light path power efficiency to the optical record carrier” means the ratio equal to the light power of the scanning spot, i.e. of the radiation beam incident to the information layer, divided by the light power of the radiation beam emitted from the radiation source.

Another measure to increase the rim intensity without decreasing the numerical aperture is to arrange a so-called “flat intensity lens” between the lens system 7 and the detection system 10, for redistributing the light in the cross-section (normal to the optical axis 12) of the radiation beam entering the lens system 7 from the central part of the cross-section to the outer part.

In the present description “flat intensity lens” means a lens that redistributes the beam incident to the lens so that, when the intensity profile of the beam in the entrance pupil of the lens is for example of the Gaussian type, the intensity profile in the exit pupil of the lens is flat. “Redistribution” means the action that adjusts the radial position of the rays of the beam so that, when the intensity of the beam in the entrance pupil of the lens has a curved profile, the intensity of the beam emerging from the lens has a substantially flat profile in the exit pupil of the lens. Flat intensity lenses are known, e.g., from the article by B. Roy Frieden, “Lossless Conversion of a Plane Laser Wave to a Plane Wave of Uniform Irradiance”, Applied Optics vol. 4 pp 1400-1403 (1965). In the present embodiment, the flat intensity lens may be integrated with another optical component of the scanning device 1.

In the following, the flat intensity lens is integrated with the collimator lens.

FIG. 10 shows the alternative embodiment 9′ of the collimator lens 9 shown in FIG. 1, where the flat intensity lens is integrated therein. As shown in FIG. 10, the collimator lens 9′ is a bi-aspherical element designed for transforming the diverging radiation beam 4 to an emerging beam that both is collimated and has its light redistributed in the cross-section (normal to the optical axis 12) of the radiation beam entering the lens system 7 from the central part of the cross-section to the outer part. The collimator lens 9′ has a thickness of 27 mm along the Z-axis (direction of its optical axis) and an entrance pupil with a diameter of 35 mm. The numerical aperture of the collimator lens 9′ is equal to 0.146 at a wavelength of 405 nm. The lens body of the collimator lens 9′ is made of COC with a refractive index equal to 1.55 at a wavelength of 405 nm. The rotational symmetric aspherical shape of the first and second surface of the collimator lens 9′ are given by the following equation:

$$H ( r ) = {\sum }_{i = 1}^{15} {B}_{2 i} {r}^{2 i}$$

where “H(r)” is the position of the surface along the optical axis of the collimator lens 9′ in millimeters, “r” is the distance to the optical axis in millimeters, and “Bₖ” is the coefficient of the k-th power of H(r). For the first surface facing the radiation source, the values of the coefficients B₂, B₄, B₆, B₈, B₁₀, B₁₂, B₁₄, B₁₆, B₁₈, B₂₀, B₂₂, B₂₄, B₂₆, B₂₈ and B₃₀ are 0.25583407, 0.0024113233, −0.0043423133, 0.016023344, −0.053352877, 0.11303222, −0.16416941, 0.16820646, −0.12356421, 0.065342503, −0.024663664, 0.0064819753, −0.0011269311, 0.00011650879 and −5.4244402E-6, respectively. For the second surface facing the position of the record carrier, the values of the coefficients B₂, B₄, B₆, B₈, B₁₀, B₁₂, B₁₄, B₁₆, B₁₈, B₂₀, B₂₂, B₂₄, B₂₆, B₂₈ and B₃₀ are 0.41351033, −0.058694854, −0.038306221, 0.00192283, 0.0080543539, −0.00018338671, −0.00014543317, −0.0028289724, 0.0021498723, 1.1288654E-005, −0.0007894134, 0.00049423085, −0.00015052765, 2.4089198E-5 and −1.6294741E-6, respectively.

While the flat intensity lens alone has the advantage of increasing the rim intensity, it has, however, the drawback that that lens is sensitive to misalignment with respect to other optical components of the scanning device 1, thereby resulting in introducing a comatic wavefront aberration W_{abb} in the radiation beam 14. For instance, if there is a linear displacement of 5 μm of the radiation source 6 along the X-axis, the value OPDᵣₘₛ of the aberration W_{abb} equals 86 mλ for the third-order coma and 26 mλ for the fifth-order coma. Also for instance, if there is a linear displacement of 1 μm between the centers of the first and second surfaces of the lens 9′ is displaced over, the value OPDᵣₘₛ of the aberration W_{abb} equals 106 mλ for the third-order coma and 39 mλ for the fifth-order coma. Also for instance, if there is an angular displacement of 0.03° between the normal to the first face and the normal to the second surface of the lens 9′, the value OPDᵣₘₛ of the aberration W_{abb} equals 133 mλ for the third-order coma and 34 mλ, for the fifth-order coma.

In order to increase the misalignment tolerance of the device, the wavefront modifier 30 is arranged between the radiation source 6 and the detection system 10, except from between the first and second surfaces of the flat intensity lens 9′. More specifically, the wavefront modifier 30 is designed for compensating the comatic aberration W_{abb} introduced by the flat intensity lens alone in case of misalignment. Thus, it can be derived from Equations (5) and (8j) that the shapes of the surfaces 301b and 302a of the first and second plates 301 and 302 of the wavefront modifier 30 are defined by the function S₁₂(x, y) given by:
S₁₂(x, y)=C₁₂(x²+y²)²+D₁₂(x²+y²)³

Also, it can be derived from Equations (1b) that, by displacing the plate 302 over the displacement “a” along the X-axis or the displacement “b” along the Y-axis, the two wavefront modifications Wₐ and W_{b} introduced by the wavefront modifier 30 are given by:

$${W}_{a} ( x , y ) \approx ( n - 1 ) a \frac{\partial {S}_{12} ( x , y )}{\partial x}$$

$${W}_{b} ( x , y ) \approx ( n - 1 ) b \frac{\partial {S}_{12} ( x , y )}{\partial y}$$

The wavefront modifications Wₐ and W_{b} can be represented in the form of the Zernike coefficients. For instance, the modification Wₐ along the X-axis may be represented as follows:
Wₐ=A₁₁Z₁₁+A₃₁Z₃₁+A₅₁Z₅₁
where “A₁₁”, “A₃₁” and “A₅₁” are the coefficients associated with the Zernike polynomials “Z₁₁”, “Z₃₁” and “Z₅₁” with

$$\begin{matrix}{A}_{11} = a ( n - 1 ) ( \frac{8}{3} {C}_{12} + 3 {D}_{12} ) \\ {A}_{31} = a ( n - 1 ) ( \frac{4}{3} {C}_{12} + \frac{12}{5} {D}_{12} ) \\ {A}_{51} = a ( n - 1 ) ( \frac{3}{5} {D}_{12} ) \end{matrix}$$

It is then found that the value OPDᵣₘₛ of the wavefront modification Wₐ equals to

$${\sum }_{k}^{} \frac{{A}_{k1}}{\sqrt{2 k + 1}} .$$

Therefore, by properly choosing of the values C₁₂ and D₁₂, the comatic wavefront modification Wₐ may substantially compensate the comatic aberration W_{abb} introduced by the flat intensity lens alone in case of misalignment. In the following, the plates 301 and 302 have been designed where the value C₁₂ equals 0, the value D₁₂ equals 0.03, and hₒ=50 μm. It has then been found by means of numerical simulations that, where the displacement “a” or “b” equals 50 μm, the value OPDᵣₘₛ of the wavefront Wₐ or “W_{b}”, respectively, equals 77 mλ for the third order coma and 15 mλ for the fifth-order coma. Thus, by using the wavefront modifier 30 in the optical scanning device 1, the converging radiation beam 16 is substantially free of comatic aberration, even in case of misalignment, while it has a high rim intensity. In other words, the scanning device 1 has a higher misalignment tolerance while allowing the scanning of optical record carriers with higher information density.

Furthermore, the wavefront modifier 30 shown in FIGS. 1 through 7 may be used for modifying a wavefront modification for optical devices other than the optical scanning device 1 shown in FIG. 1. For instance, the wavefront modifier is suitable for a zoom lens; it generates a wavefront modification in the form of defocus in order to change the focal length of the zoom lens, thereby making the focal length adjustable.

1. An optical scanning device for scanning an information layer of an optical record carrier by means of a radiation beam, including:
a radiation source for providing said radiation beam,
a lens system for transforming said radiation beam to a converging radiation beam so as to form a scanning spot in the position of the information layer, the lens system including a first objective lens having an optical axis, and
a wavefront modifier arranged between said radiation source and the position of said scanning spot for transforming a first radiation beam into a second radiation beam, the wavefront modifier including a first element having a first aspheric surface and a second element having a second aspheric surface, said first and second elements being mutually linearly movable for introducing a wavefront modification in said second radiation beam,
characterized in that said first and second aspheric surfaces are shaped so that:
a first mutual linear displacement of said first and second elements over a first distance along a first axis introduces a first wavefront modification along said first axis in said second radiation beam, and that
a second mutual linear displacement of said first and second elements over a second distance along a different, second axis introduces a second wavefront modification along said second axis in said second radiation beam.

2. The optical scanning device as claimed in claim 1, wherein the shape of said first aspheric surface is substantially defined by a function S′(x, y) and the shape of said second aspheric surfaces is substantially defined by a function S″(x, y), the functions S′(x, y) and S″(x, y) being determined by:
$${W}_{a} ( x , y ) \approx ( {n}_{1} - 1 ) {a}_{1} \frac{\partial {S}^{′} ( x , y )}{\partial x} - ( {n}_{2} - 1 ) {a}_{2} \frac{\partial {S}^{″} ( x , y )}{\partial x}$$
$${W}_{b} ( x , y ) \approx ( {n}_{1} - 1 ) {b}_{1} \frac{\partial {S}^{′} ( x , y )}{\partial y} - ( {n}_{2} - 1 ) {b}_{2} \frac{\partial {S}^{″} ( x , y )}{\partial y}$$
where “(x, y)” are Cartesian coordinates in the system X_{O}Y_{O} in a reference plane, the system having its origin on the point of intersection of said optical axis and said reference plane, the X_{O}-axis and the Y_{O}-axis being said first and second axes, respectively, “a,” and “a₂” being the respective displacements of said first and second elements along the X_{O}-axis in case of said first mutual linear displacement, “b₁” and “b₂” being the respective displacements of said first and second elements along the Y_{O}-axis in case of said second mutual linear displacement, “n₁” and “n₂” being the respective optical indices of said first and second elements, and “S′(x, y)” and “S″(x, y)” representing the respective shapes of said first and second aspheric surfaces.

3. The optical scanning device as claimed in claim 2, wherein the shapes of said first and second aspheric surfaces are substantially identical and substantially defined by a function S(x, y) determined by:
$${W}_{a} ( x , y ) \approx ( {n}_{1} - 1 ) a \frac{\partial S ( x , y )}{\partial x}$$
$${W}_{b} ( x , y ) \approx ( {n}_{1} - 1 ) b \frac{\partial S ( x , y )}{\partial y}$$
where “a” and “b” being said first and second displacements, respectively, “n” being the optical indices of said first and second elements, and “S(x, y)” representing the respective shapes of said first and second aspheric surfaces.

4. The optical scanning device as claimed in claim 2, wherein said function(s) S(x, y), S′(x, y) and/or S″(x, y) include(s):
a first term “(x²+y²)²” in order to introduce said first and second wavefront modifications in the form of third-order coma,
a second term “x²+D₂y²” in order to introduce said first and second wavefront modifications in the form of tilt, where “D₂” is a non-zero parameter constant in terms of the Cartesian coordinates (x, y),
a third term “x³+D₃y²” in order to introduce said first and second wavefront modifications in the form of astigmatism and tilt, respectively, where “D₃” is a non-zero parameter constant in terms of the Cartesian coordinates (x, y),
a fourth term “x⁴+D₄y²” in order to introduce said first and second wavefront modifications in the form of line coma and tilt, respectively, where “D₄” is a non-zero parameter constant in terms of the Cartesian coordinates (x, y),
a fifth term “x²+D₅y³” in order to introduce said first and second wavefront modifications in the form of tilt and astigmatism, respectively, where “D₅” is a non-zero parameter constant in terms of the Cartesian coordinates (x, y),
a sixth term “x³+D₆y³” in order to introduce said first and second wavefront modifications in the form of astigmatism, where “D₆” is a non-zero parameter constant in terms of the Cartesian coordinates (x, y),
a seventh term “x⁴+D₇y³” in order to introduce said first and second wavefront modifications in the form of line coma and astigmatism, respectively, where “D₇” is a non-zero parameter constant in terms of the Cartesian coordinates (x, y),
an eighth term “x²+D₈y⁴” in order to introduce said first and second wavefront modifications in the form of tilt and line coma, respectively, where “D₈” is a non-zero parameter constant in terms of the Cartesian coordinates (x, y),
a ninth term “x³+D₉y⁴” in order to introduce said first and second wavefront modifications in the form of astigmatism and line coma, respectively, where “D₉” is a non-zero parameter constant in terms of the Cartesian coordinates (x, y),
a tenth term “x⁴+D₁₀y⁴” in order to introduce said first and second wavefront modifications in the form of line coma, where “D₁₀” is a non-zero parameter constant in terms of the Cartesian coordinates (x, y) or
an eleventh term “(x²+y²)³” in order to introduce said first and second wavefront modifications in the form of fifth-order coma.

5. The optical scanning device as claimed in claim 2, wherein said function(s) S(x, y), S′(x, y) and/or S″(x, y) include(s) at least a step-function Q(x, y) which equals:
a nonzero constant parameter for a portion of the corresponding aspheric surface, that parameter being substantially equal to mλ/(n−1) where “λ” is the wavelength of the radiation beam in the optical path of which said wavefront modifier is arranged, “m” is an integer value and “n” is the refractive index of the corresponding element, and
zero for the remaining part of that surface.

6. The optical scanning device as claimed in claim 1, further including a flat intensity lens for increasing the rim intensity of said converging radiation beam, wherein said first and second aspheric surfaces are shaped so that said first and/or second wavefront modification(s) are capable of substantially compensating a comatic wavefront aberration introduced by said flat intensity lens.

7. The optical scanning device as claimed in claim 1, further including an aberration compensator for compensating a first wavefront aberrations and a second wavefront modification which are present in said second radiation beam, the compensator including:
an aberration detector for providing a first detection signal and a second detection signal representative of said first and second wavefront aberrations, respectively, and
said wavefront modifier arranged for, in response to said detection signal, introducing said first wavefront modification and said second wavefront modification so that said second radiation beam is substantially free of aberration.

8. The optical scanning device as claimed in claim 1, characterized in that said detection system is arranged for providing a focus error signal and/or a radial-tracking error signal and in that it further includes a servo circuit and an actuator responsive to said focus error signal and/or said radial-tracking error signal for controlling the positions of said scanning spot with respect to the position of said information layer and/or of a track of said information layer which is to be scanned.

9. The optical scanning device as claimed in claim 1, further including an information processing unit for error correction.

10. A wavefront modifier for transforming a first radiation beam into a second radiation beam, the wavefront modifier including a first element having a first aspheric surface and a second element having a second aspheric surface, said first and second elements being mutually linearly movable for introducing a wavefront modification in said second radiation beam, characterized in that said first and second aspheric surfaces are shaped so that:
a first mutual linear displacement of said first and second elements over a first distance along a first axis introduces a first wavefront modification along said first axis in said second radiation beam, and that
a second mutual linear displacement of said first and second elements over a second distance along a different, second axis introduces a second wavefront modification along said second axis in said second radiation beam.
